(19) United States
(12) Patent Application Publication
(10) Pub. No.: US 2005/0287378 A1
(43) Pub. Date: Dec. 29, 2005

(54) Metallized or ceramic-coated polyester films comprising poly(m-xyleneadipamide)

(76) Inventors: Oliver Klein, Mainz (DE); Herbert Peiffer, Mainz (DE); Richard Lee Davis, Wiesbaden (DE)

Correspondence Address: PROPAT, L.L.C., 425-C SOUTH SHARON AMITY ROAD, CHARLOTTE, NC, 28211-2841, US

(21) Appl. No.: 11/152,467

(22) Filed: Jun. 14, 2005

(30) Foreign Application Priority Data
Jun. 26, 2004 (DE) 10 2004 030 977.9

(51) Int. Cl. B32B 27/36; B32B 15/08

(52) U.S. Cl. 428/458; 428/910; 428/480; 156/229

(57) ABSTRACT

Polyester films which comprise not only thermoplastic polyester, e.g. polyethylene terephthalate, but also from 5 to 45% by weight of poly(m-xyleneadipamide) and optionally from 0.02 to 1% by weight of fillers. The polyester films have been ceramic-coated or metallized on at least one surface, and are produced by a sequential stretching process. The films of the invention feature improved mechanical properties, such as a modulus of elasticity greater than 3500 N/mm² in both orientation directions, high gloss, low haze, and very good barrier properties with respect to oxygen transmission. The inventive films are therefore a suitable packaging material for foods and other consumable items.

### CROSS-REFERENCE TO RELATED APPLICATIONS

This application claims priority to German parent application 10 2004 030 977.9, which is hereby incorporated by reference in its entirety.

### FIELD OF THE INVENTION

The invention relates to a biaxially oriented polyester film which comprises polyester and poly(m-xyleneadipamide) and which has been metallic- or ceramic-coated on at least one side. The invention further relates to a process for the production of the film and to its use.

### BACKGROUND OF THE INVENTION

Packaging for food or drink often requires a high level of barrier action (equivalent to low permeability) with respect to gases, water vapor, and odors.

Biaxially oriented polyester films which feature a high level of barrier action, i.e. an improved barrier, are known in the prior art. In most instances, the films obtain their improved barrier off-line after the production process, via a further processing step. Examples here are extrusion coating, coating or lamination with barrier materials, or plasma polymerization combined with vacuum coating. Another commonly used process for producing packaging of this type consists in using aluminum in a high vacuum to metallize the plastics films used for this purpose. Another commonly used process consists in coating the films with ceramic materials, such as SiOₓ, AlxO_{y}, or MgOₓ. Examples of methods for this process are PVD, CVD, or PECVD. The level of barrier action with respect to the abovementioned substances is substantially dependent on the nature of the polymers in the film and on the quality of the barrier layers applied. For example, metallized, biaxially oriented polyester films have a very high level of barrier action with respect to gases, such as oxygen, and odors. Metallized, biaxially oriented polypropylene films in turn present a high barrier to water vapor.

WO 99/62694 gives a relatively detailed description of a process in which a multilayer, coextruded polyester film which comprises at least one layer comprised of EVOH (ethylene-vinyl alcohol) is simultaneously biaxially oriented. This film features good mechanical properties, but in particular features good barrier properties with respect to oxygen transmission. The best achievable value for oxygen transmission OTR (oxygen transmission rate) is given in the specification as 5 cm³/(m²·bar·d). A disadvantage of the process is, inter alia, that the regrind produced during the production process cannot be reintroduced into the production process without sacrificing the good optical and physical properties of the film.

The film of EP-A-0 675 158 is a stretched composite film based on polyester with improved barrier properties with respect to gases. The film has been coated at least on one of the two sides with a layer of thickness 0.3 μm or less comprised of polyvinyl alcohol whose number-average degree of polymerization is 350 or more, the average roughness R_{z} of the side to be coated of the base film being 0.30 μm or less, and this side being characterized by a certain distribution of the elevations on the film surface. The oxygen transmission of this composite film is less than 3 cm³/(m²·bar·d). A disadvantage of this composite film is its low resistance, for example with respect to moisture. On contact with water or water vapor, the adhesion of the barrier coating comprised of polyvinyl alcohol to the polyester film is lost with the result that the barrier coating can be washed off the polyester film.

JP 2001-001399 describes a transparent biaxially oriented film which is comprised of a mixture of polyethylene terephthalate and poly(m-xyleneadipamide) (MXD6). The proportion of poly(m-xyleneadipamide) (MXD6) in the film is from 10 to 40% by weight, and the corresponding proportion of polyethylene terephthalate is from 60 to 90% by weight. According to the invention, the film is simultaneously biaxially oriented. The specification gives the following data for the stretching parameters:

The stretching ratios in both directions are from 2.5 to 5.0. However, in the examples the film is only oriented by a factor of 3.0 in the machine direction and by a factor of 3.3 transversely to the machine direction. The overall stretching ratio is therefore 9.9. The stretching temperatures in both directions are from 80 to 140° C. In the examples, the film is stretched in both directions at 90° C.

According to JP 2001-001399, when a simultaneously oriented film is compared with a sequentially oriented film (e.g. oriented first in machine direction (MD or MDO) and then in the transverse direction (TD or TDO)), it has lower haze and gives more dependable processing, i.e. can be produced with a smaller number of break-offs in the second stretching phase (e.g. in the transverse direction). According to the above specification, the degree of crystallization that occurs during the sequential (non-inventive) orientation in the first stretching step (e.g. MDO) is so great that the film becomes cloudy during the second (subsequent) orientation process and becomes more delicate with respect to any further orientation process. According to the (comparative) Examples 3 and 4 set out in the specification, a polyester film with from 10 to 40% of MXD6 cannot be produced by the sequential process, because is tears in the second stretching phase.

The biaxially oriented films produced according to JP 2001-001399 by the simultaneous process feature low haze, but in particular feature good barrier action with regard to oxygen permeation. The film achieves an oxygen transmission OTR smaller than 30 cm³/(m²·bar·d). According to the invention, the haze of the film is smaller than 15%. However, the film has a number of disadvantages:

It has a comparatively low level of mechanical properties. In particular, the modulus of elasticity and the ultimate tensile strength are unsatisfactory.

It tends to block and is therefore difficult to wind.

It has comparatively rough surfaces. The film also has a matt appearance, undesirable for many applications. It is therefore also comparatively difficult to print, to metallize, or to coat.

### SUMMARY OF THE INVENTION

It was an object of the present invention to provide a biaxially oriented polyester film which features a high barrier to oxygen (where the amount of oxygen diffusing through the film per square meter and per day when it is exposed to air at a pressure of 1 bar should be less than 1 cm³).

The film should moreover have the following advantageous properties/combinations of properties when compared with films of the prior art:

a higher level of mechanical properties, in particular a higher modulus of elasticity,

high gloss and therefore good printability, good metallizability, and good coatability,

good windability (without blocking) and capability for processing to give a customer roll without winding defects,

capability for cost-effective production; by way of example this means that conventional stretching processes which can operate at high speed, e.g. above 350 m/min (above 400 m/min) can be used for industrial production of the film; there should be no need to use the expensive simultaneous stretching process which, according to the prior art, operates at markedly lower speed (<350 m/min) and width (<5 m) and is therefore less cost-effective, an amount which is preferably from 5 up to 60% by weight of the regrind produced during production of the film should be capable of reintroduction into the production process (extrusion and biaxial orientation) without any resultant significant adverse effect on the physical and optical properties of the film, but in particular on the barrier properties with respect to oxygen.

The other properties of the film should be at least equivalent to those of the known packaging films of this type.

### BRIEF DESCRIPTION OF THE DRAWINGS

FIG. 1 is a cross-sectional schematic illustration of an exemplary single layer film in accordance with the invention;

FIG. 2 is a cross-sectional schematic illustration of an exemplary three layer film in accordance with the invention;

FIG. 3 is a schematic illustration of an exemplary single gap stretching process in accordance with the invention; and

FIG. 4 is a schematic illustration of an exemplary two-stage stretching process in accordance with the invention.

### DETAILED DESCRIPTION OF THE INVENTION

The object is achieved via a biaxially oriented polyester film which is preferably produced by the sequential stretching process and which comprises a concentration which is preferably from 5 to 45% by weight of poly(m-xyleneadipamide) (MXD6), has a modulus of elasticity which is preferably at least 3500 N/mm² in both orientation directions, and has been ceramic-coated or metallized on at least one film surface.

The film preferably comprises a concentration of fillers which is preferably from 0.02 to 1% by weight.

The film also comprises a thermoplastic polyester, its amount preferably being at least 55% by weight. The proportion of poly(m-xyleneadipamide) in the film is preferably from 5 to 45% by weight, in particular from 5 to 40% by weight.

Unless otherwise stated, all % by weight data are based on the total weight of the inventive film.

Poly(m-xyleneadipamide) (MXD6), also termed poly-m-xyleneadipamide or PA-MXD6, is a polycondensate (polyarylamide) comprised of m-xylylenediamine and adipic acid and is marketed in various grades, all of which are in principle suitable for the inventive purpose. However, preference is given to grades whose melt viscosity is smaller than 6000 poise (=600 Pa.s, T=280° C., shear rate γₚₒᵢₙₜ ≧100 s⁻¹).

When compared with films of the prior art, the biaxially oriented polyester film of the present invention, ceramic-coated or metallized at least on one surface, has better mechanical and better optical properties, and also in particular has increased gloss (and the latter applies not only to the transparent film but also to the metallized or ceramic-coated film). The metallized or ceramic-coated film moreover features excellent barrier properties, in particular with respect to transmission of gases such as oxygen.

The oxygen transmission (OTR) of the metallized or ceramic-coated film is preferably less than 0.5 cm³/(m²·bar·d) if it has been metallized, or less than 1.0 cm³/(m²·bar·d)if it has been ceramic-coated; based on a film of thickness 12 μm.

The film also exhibits the desired processing and winding behavior. In particular, it exhibits no tendency to adhere to rollers or to other mechanical parts, no blocking problems, and no longitudinal corrugations during winding. The film can readily produce a customer roll with very good winding quality.

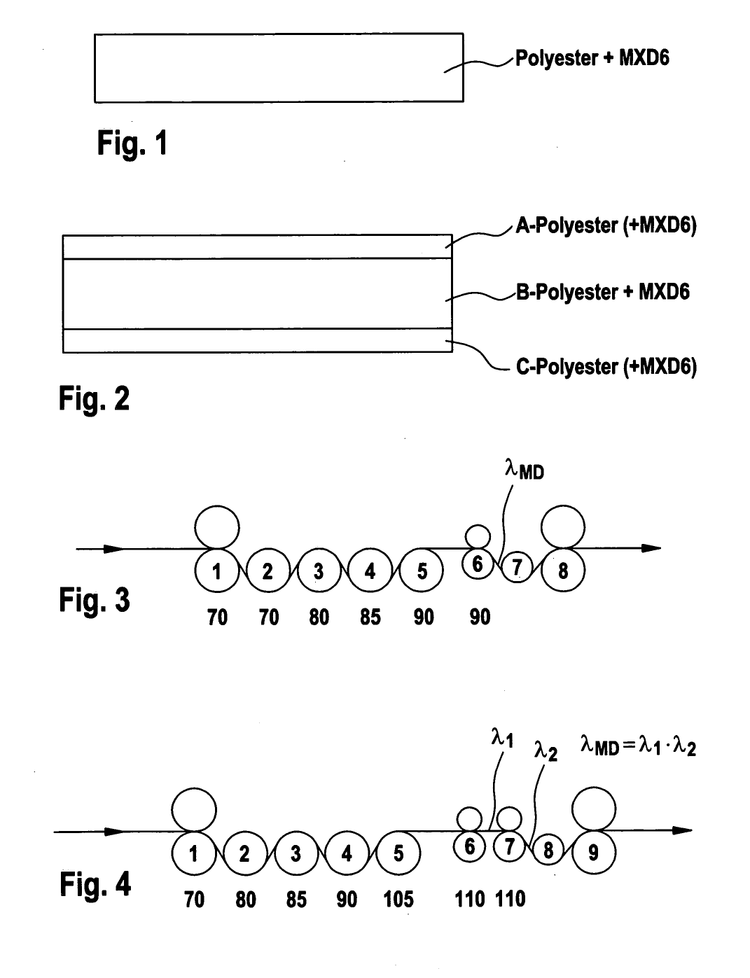

The film of the present invention is preferably comprised of the inventive polymer mixture. In this case, the film has a single-layer structure (cf. FIG. 1). In another inventive embodiment, the film has a multilayer structure, for example a three-layer structure (cf. FIG. 2). It is then comprised, by way of example of the inventive base layer (B), of the outer layer (A) applied on one side of the base layer (B), and also of the outer layer (C) applied on the other side of the base layer (B). The layers (A) and (C) may be identical or different.

The film, or the base layer of the film, is preferably comprised of at least 55% by weight of thermoplastic polyester (=component I). Examples of materials suitable for this are polyesters comprised of ethylene glycol and terephthalic acid(polyethylene terephthalate, PET), ethylene glycol and naphthalene-2,6-dicarboxylic acid(polyethylene 2,6-naphthalate, PEN), 1,4-bishydroxymethylcyclohexane and terephthalic acid(poly-1,4-cyclohexanedimethylene terephthalate, PCDT), or else made from ethylene glycol, naphthalene-2,6-dicarboxylic acid and biphenyl-4,4′-dicarboxylic acid(polyethylene 2,6-naphthalate bibenzoate, PENBB). Preference is given to polyesters comprised of at least 90 mol %, in particular at least 95 mol %, of ethylene glycol units and terephthalic acid units, or of ethylene glycol units and naphthalene-2,6-dicarboxylic acid units. The remaining monomer units derive from other diols and other dicarboxylic acids. For component I of the film, or of the base layer (B), it is also advantageously possible to use copolymers or mixtures or blends comprised of the homo- and/or copolymers mentioned.

For the last-mentioned case it is particularly advantageous for the component I used in the film or in the base layer (B) to comprise a polyester copolymer based on isophthalic acid and terephthalic acid or based on terephthalic acid and naphthalene-2,6-dicarboxylic acid. In this case, the film is easy to produce and the optical properties of the film are particularly good, as also are the barrier properties achieved in the film. One particular advantage is that if, for example, a polyester copolymer based on isophthalic acid and terephthalic acid is used the extrusion temperature can be lowered, and this is particularly advantageous for processing of the MXD6. If, by way of example, 280° C. is required for the extrusion of polyethylene terephthalate, the extrusion temperature can be lowered to below 260° C. if a polyester copolymer based on isophthalic acid and terephthalic acid is used. The MXD6 then remains ductile for the stretching phase that follows, and this is discernible, by way of example, in high process stability and in very good mechanical properties.

In this case, component I of the film or of the base layer (B) of the film in essence comprises a polyester copolymer comprised predominantly of isophthalic acid units and of terephthalic acid units and of ethylene glycol units, and component II of the film comprises in essence the abovementioned inventive poly(m-xyleneadipamide) (MXD6). However, mixtures comprised of polyethylene terephthalate and polyethylene isophthalate are also preferred as component I.

The preferred copolyesters (component I), which provide the desired properties of the film (in particular the optical properties, together with orientability) are those comprised of terephthalate units and of isophthalic units, and of ethylene glycol units. The proportion of ethylene terephthalate in these copolymers is preferably from 70 to 98 mol %, and the corresponding proportion of ethylene isophthalate is from 30 to 2 mol %. Among these, preference is in turn given to those copolyesters in which the proportion of ethylene terephthalate is from 76 to 98 mol %, and the corresponding proportion of ethylene isophthalate is from 24 to 2 mol %, and very particular preference is given to those copolyesters in which the proportion of ethylene terephthalate is from 80 to 98 mol % and the corresponding proportion of ethylene isophthalate is from 20 to 2 mol %.

Examples of other suitable aliphatic diols which may be constituents of the inventive polyesters are diethylene glycol, triethylene glycol, aliphatic glycols of the formula HO—(CH₂)ₙ—OH, where n is an integer from 2 to 6 (in particular 1,3-propanediol, 1,4-butanediol, 1,5-pentanediol and 1,6-hexanediol) and branched aliphatic glycols having up to 6 carbon atoms, and cycloaliphatic diols having one or more rings and, if appropriate, containing heteroatoms. Among the cycloaliphatic diols, mention should be made of cyclohexanediols (in particular 1,4-cyclohexanediol). Examples of suitable other aromatic diols have the formula HO—C₆H₄—X—C₆H₄—OH, where X is —CH₂—, —C(CH₃)₂—, —C(CF₃)₂—, —O—, —S— or —SO₂—. Bisphenols of the formula HO—C₆H₄—C₆H₄—OH are also very suitable.

Suitable other aromatic dicarboxylic acids which may be constituents of the inventive polyesters are preferably benzenedicarboxylic acids, naphthalene dicarboxylic acids (such as naphthalene-1,4- or -1,6-dicarboxylic acid), biphenyl-x,x′-dicarboxylic acids (in particular biphenyl-4,4′-dicarboxylic acid), diphenylacetylene-x,x′-dicarboxylic acids (in particular diphenylacetylene-4,4′-dicarboxylic acid) or stilbene-x,x′-dicarboxylic acids. Among the cycloaliphatic dicarboxylic acids mention should be made of cyclohexanedicarboxylic acids (in particular cyclohexane-1,4-dicarboxylic acid). Among the aliphatic dicarboxylic acids, the C₃-C₁₉ alkanediacids are particularly suitable, and the alkane moiety here may be straight-chain or branched.

One way of preparing the polyesters is the known transesterification process. Here, the starting materials are dicarboxylic esters and diols, which are reacted using the customary transesterification catalysts, such as the salts of zinc, of calcium, of lithium or of manganese. The intermediates are then polycondensed in the presence of well known polycondensation catalysts, such as antimony trioxide or titanium salts. Another equally good preparation method is the direct esterification process in the presence of polycondensation catalysts. This starts directly from the dicarboxylic acids and the diols. The inventive polyesters are moreover obtainable from various producers.

According to the invention, the base layer (B) or the film comprises an amount of in particular from 5 to 40% by weight and particularly preferably from 5 to 35% by weight of poly(m-xyleneadipamide) (MXD6) (=component II) as another component.

For the processing of the polymers it has proven advantageous for the poly(m-xyleneadipamide) (MXD6) to be selected in such a way that the viscosities of the respective polymer melts do not differ excessively. Otherwise, additional elevations/protrusions, flow disruption, or streaking on the finished film can sometimes be expected. Furthermore, the polymers then tend to separate. In accordance with the experiments carried out here, the melt viscosity of the the poly(m-xyleneadipamide) (MXD6) should preferably be below certain values. For the purposes of the present invention, very good results are obtained if the melt viscosity of the MXD6 is smaller than 6000 poise (measured in a capillary rheometer of diameter 0.1 mm, of length 10 mm, and with a shear rate of γₚₒᵢₙₜ ≧100 s-¹, melt temperature 280° C.), preferably smaller than 5000 poise, and particularly preferably smaller than 4000 poise.

Similar factors also apply to the viscosity of the polyester used. For the purposes of the present invention, very good results are obtained if the melt viscosity of the polyester is smaller than 2400 poise (measured in a capillary rheometer of diameter 0.1 mm, of length 10 mm, and with a shear rate of γₚₒᵢₙₜ ≧100 s-¹, melt temperature 280° C.), preferably smaller than 2200 poise, and particularly preferably smaller than 2000 poise.

The form in which the poly(m-xyleneadipamide) (MXD6) is incorporated into the film is advantageously either that of pure pelletized material or that of pelletized concentrate (masterbatch). In the case of processing by way of a masterbatch, its concentration is preferably from 10 to 60% by weight of MXD6. To this end, the pelletized polyester is premixed with the poly(m-xyleneadipamide) (MXD6) or with the poly(m-xyleneadipamide) (MXD6) masterbatch, and then introduced into the extruder. In the extruder, the components are further mixed and heated to processing temperature. It is advantageous here for the inventive process if the extrusion temperature is above the melting point T_{M} of the poly(m-xyleneadipamide) (MXD6), generally above the melting point of the poly(m-xyleneadipamide) (MXD6) by at least 5° C., preferably by from 5 to 50° C., in particular however by from 5 to 40° C. A twin-screw extruder is clearly a preferred extrusion unit for the processing of the mixture, and also for the preparation of the masterbatch from components I and II. Another factor which should be mentioned is that good results are achieved even with a single-screw extruder, and therefore that this principle is generally applicable.

The film of the present invention has at least a single-layer structure. In this case it is then comprised of the inventive mixture comprised of polyester and MXD6, and also of the metallic or ceramic layer(s) applied. The film may moreover have additional layers, termed outer layers or intermediate layers. Typical film structures are then ABA or ABC, where A and C are appropriate outer layers and B is the base layer. The outer layers A and C may be identical or different.

The polymers used for the outer layers may in principle be (polyester) polymers identical with those used for the base layer B. However, other materials may also be present in the outer layers, in which case the outer layers are then preferably comprised of a mixture of polymers, of copolymers, or of homopolymers, preferably comprising ethylene isophthalate units and/or ethylene 2,6-naphthalate units and/or ethylene terephthalate units. Up to 10 mol % of the polymers may be comprised of other comonomers.

Copolymers or mixtures or blends comprised of homo- and/or copolymers may also advantageously be used as other components for the outer layers.

It is particularly advantageous to use a polyester copolymer based on isophthalic acid and terephthalic acid in the outer layers. In this case, the optical properties of the film are particularly good, and the film moreover has particularly good suitability for subsequent metallization or ceramic coating.

In this case, the outer layer(s) of the film in essence comprise(s) a polyester copolymer which is mainly comprised of isophthalic acid units and of terephthalic acid units, and of ethylene glycol units. The remaining monomer units derive from the other aliphatic, cycloaliphatic, or aromatic diols or, respectively, carboxylic acids which may also be present in the base layer. The preferred copolyesters which provide the desired properties of the film (in particular the optical properties) are those comprised of terephthalate units and of isophthalate units, and of ethylene glycol units. The proportion of ethylene terephthalate is from 40 to 97 mol %, and the corresponding proportion of ethylene isophthalate is from 60 to 3 mol %. Preference is given to copolyesters in which the proportion of ethylene terephthalate is from 50 to 90 mol % and the corresponding proportion of ethylene isophthalate is from 50 to 10 mol %, and very particular preference is given to copolyesters in which the proportion of ethylene terephthalate is from 60 to 85 mol % and the corresponding proportion of ethylene isophthalate is from 40 to 15 mol %.

The outer layer(s) may also comprise poly(m-xyleneadipamide) (MXD6), as described in more detail above for the base layer (B). The proportion by weight of poly(m-xyleneadipamide) (MXD6) in the outer layer(s) here is advantageously from 0.1 to 80% by weight, preferably from 0.3 to 75% by weight, and particularly preferably from 0.5 to 70% by weight, based on the weight of the outer layer(s). The MXD6-containing outer layer has particularly good suitability for subsequent metallization or ceramic coating. In another preferred embodiment of the invention, the outer layer(s) comprise(s) no poly(m-xyleneadipamide) (MXD6).

The thickness of the outer layers is preferably greater than 0.3 μm, and is preferably in the range from 0.5 to 20 μm, and particularly preferably in the range from 1.0 to 10 μm.

The base layer (B) and any outer and intermediate layers present may also comprise conventional additives, e.g. stabilizers and/or antiblocking agents. They are advantageously added to the polymer or polymer mixture before melting begins. Examples of stabilizers used are phosphorus compounds, such as phosphoric acid or phosphoric esters.

Typical antiblocking agents (also termed pigments or filters in this context) are inorganic and/or organic particles, such as calcium carbonate, amorphous silica, talc, magnesium carbonate, barium carbonate, calcium sulfate, barium sulfate, lithium phosphate, calcium phosphate, magnesium phosphate, aluminum oxide, lithium fluoride, the calcium, barium, zinc, or manganese salts of the dicarboxylic acids used, carbon black, titanium dioxide, kaolin, or crosslinked polystyrene particles, or crosslinked acrylate particles.

Other additives which may be selected are mixtures of two or more different antiblocking agents or mixtures of antiblocking agents of the same constitution but different particle size. The particles may be added to the individual layers in conventional concentrations, e.g. in the form of a glycolic dispersion during the polycondensation process, or by way of masterbatches during the extrusion process (or else in the form of “direct additive addition” [DAA] directly into the extruder during the extrusion process).

According to the invention, the film comprises fillers at a concentration which is preferably from 0.02 to 1% by weight, and preferably comprises fillers at a concentration of from 0.04 to 0.8% by weight, and particularly preferably comprises fillers at a concentration of from 0.06 to 0.6% by weight, based on the weight of the film. (EP-A-0 602 964 gives by way of example a detailed description of suitable fillers and suitable antiblocking agents.)

If the filler concentration is less than 0.02% by weight, the film can block and then, by way of example, can no longer be wound. If, in contrast, the filler concentration is more than 1.0% by weight, the film sometimes loses its high transparency and becomes cloudy, it cannot then be used as a packaging film, for example.

In one preferred embodiment of the invention, the proportion of filler in the outer layers (A and/or C) is less than 0.6% by weight, preferably less than 0.5% by weight, and particularly preferably less than 0.4% by weight, based on the weight of the respective outer layer. In one particularly preferred embodiment, the outer layer to be metallized or to be coated with ceramic material comprises a very small amount (smaller than 0.1% by weight) of fillers, or no fillers at all.

By way of example, the inventive film has excellent suitability for the packaging of food or drink (e.g. cheese, meat, coffee, etc.). The film has excellent resistance to solvents and also to water. By way of example, it has been found that when the inventive film is extracted for two hours in a water-vapor atmosphere at 121° C. the amount of material extracted is below the measurable limit.

The total thickness of the inventive polyester film can vary within wide limits and depends on the intended use. It is generally from 6 to 300 μm, preferably from 8 to 200 μm, particularly preferably from 10 to 100 μm, and if outer layers have been applied here the proportion made up by the base layer (B) is preferably from 40 to 99%, based on the total thickness.

The present invention also provides a process for production of the film. The process encompasses
a) production of a film from base and any outer layers present via extrusion or coextrusion,
b) biaxial orientation of the film,
c) heat-setting of the oriented film, and
d) application of the metallic or of the ceramic layer off-line to the heat-set film.

For production of the film, it is advantageous to introduce the respective components (component I=polyester homo- or copolymer or a mixture thereof, component II=pelletized poly(m-xyleneadipamide) (MXD6)) directly into the extruder. The materials can be extruded at about 250-300° C. For process-technology reasons (thorough mixing of the various polymers) it has proven particularly advantageous here to extrude the mixture in a twin-screw extruder with capability of devolatilization (although a single-screw extruder can also be used successfully in a less preferred variant).

The polymers for any outer layers (C and/or A) present are advantageously introduced into the (coextrusion) system by way of other extruders; here again, twin-screw extruders are in principle to be preferred over single-screw extruders. The melts are shaped in a coextrusion die to give flat melt films and mutually superposed in layers. The multilayer film is then drawn off and solidified with the aid of a chill roller and, if appropriate, other rollers.

According to the invention, the biaxial stretching process is carried out sequentially. It is preferable here to begin by stretching longitudinally (i.e. in machine direction MD) and then to stretch transversely (i.e. perpendicularly to the machine direction, TD). By way of example, the longitudinal stretching can be carried out with the aid of two rollers rotating at different speeds corresponding to the desired stretching ratio. For the transverse stretching process use is generally made of an appropriate tenter frame.

The temperature at which the biaxial stretching process is carried out can vary within a relatively wide range, and depends on the desired properties of the film.

According to the invention, the film is stretched longitudinally (MDO) in a temperature range from, preferably, 80 (heating temperatures 80-130° C., depending on the stretching ratio and on the stretching process used) to 130° C. (stretching temperatures 80-130° C., depending on the stretching ratio and on the stretching process used), and the transverse stretching process is carried out in a temperature range from, preferably, 90 (start of the stretching process) to 140° C. (end of the stretching process).

According to the invention, the longitudinal stretching ratio is greater than 3.0, and is preferably in the range from 3.1:1 to 5.0:1, preferably in the range from 3.2:1 to 4.9:1, and particularly preferably in the range from 3.3:1 to 4.8:1. According to the invention, the transverse stretching ratio is greater than 3.0, and is preferably in the range from 3.2:1 to 5.0:1, preferably in the range from 3.3:1 to 4.8:1, and particularly preferably in the range from 3.4:1 to 4.6:1.

The longitudinal orientation of the film may be carried out by standard methods, e.g. with the aid of two rollers rotating at different speeds corresponding to the desired stretching ratio. This is called single-gap stretching. In this stretching process, the film is heated to the stretching temperature on two or more preheat rollers arranged in series, and is stretched by the desired stretching ratio λ_{MD} (cf. FIG. 3) by means of two rollers running at different speeds. The temperature of the film during the orientation process is preferably in the range from 80 to 100° C., and depends on the material (mixing ratio of, by way of example, PET and MXD6) that is stretched, and on the stretching ratio λ_{MD}. The temperature of the film may be measured by means of IR, for example. Accordingly, the heating temperature is likewise preferably from 80 to 100° C., and in essence depends on the stretching temperature set. FIG. 3 shows the situation by way of example for an arrangement of 5 heating rollers (1-5) and of two stretching rollers (6-7). For a stretching temperature of 90° C., examples of the temperatures of the heating rollers are 70, 70, 80, 85, and 90° C.

The longitudinal orientation of the film is preferably carried out in a multistage process, particularly preferably in a two-stage process, e.g. with the aid of two or more rollers running at different speeds corresponding to the desired stretching ratio. In the case of the two-stage stretching process, the film is preferably oriented by the process published in EP-A-0 049 108, whose United States equivalent is US Pat. No.4,370,291 (cf. FIG. 4, which corresponds to FIG. 1 from EP-A-0 049 108). In this process, the film is heated to the stretching temperature on two or more preheat rollers arranged in series and is stretched by the desired stretching ratio λ_{MD} by means of two or more rollers running at different speeds (3 rollers being used for stretching in the two-stage stretching process according to FIG. 1 of EP-A-0 049 108) (cf. FIG. 4). According to the invention, the longitudinal stretching ratio λ_{MD} (where λ_{MD} corresponds to the overall stretching ratio λ₁λ₂ of EP-A-0 049 108) is greater than 3.0 and is preferably in the range from 3.1:1 to 5.0:1, preferably in the range from 3.2:1 to 4.9:1, and particularly preferably in the range from 3.3:1 to 4.8:1. The temperature of the film during the orientation process is preferably in the range from 80 to 130° C., and depends on the material (mixing ratio of, for example, PET and MXD6) that is being stretched, and on the stretching ratio λ_{MD}. Accordingly, the heating temperature is likewise from 80 to 130° C., and depends in essence on the stretching temperature set. FIG. 4 shows the situation for an arrangement of 5 heating rollers (1-5) and of three stretching rollers (6-8). For a stretching temperature of 110° C., examples of the temperatures of the heating rollers are 70, 80, 85, 90, 105, 110, and 110° C.

In the heat-setting process which follows, the film is kept at a temperature of about 150-250° C. for a period of about 0.1-10 s. The film is then wound up conventionally.

Prior to the transverse stretching process, one or both surfaces of the film may be coated in-line by the known processes. The in-line coating process can, by way of example, give better adhesion of the metal layer or of any printing ink applied, but can also serve to improve antistatic behavior or processing behavior.

The biaxially oriented and heat-set polyester film may moreover be corona-, flame- or plasma-treated prior to application of the metallic or of the ceramic layer on one or both sides. The treatment intensity selected is such that the surface tension of the film is generally above 45 mN/m.

Application of the metallic layer or of the ceramic layer advantageously takes place on well-known industrial systems. Metal layers comprised of aluminum are usually produced via metallization (e.g. boat method of evaporation), whereas ceramic layers are also produced using electron-beam processes or applied by sputtering. The process parameters for the system during application of the metal layer or of the ceramic layer to the films correspond to standard conditions.

The metallization of the films is preferably carried out in such a way that the optical density of the metallized films is in the conventional range of about 2.2-3.2. Application of the ceramic layer to the film is carried out in such a way that the thickness of the oxide layer is preferably in the range from 10 to 200 nm. For all settings of variables, the web speed of the film to be coated is preferably from 2 to 10 m/s.

The metal layer is preferably comprised of aluminum. However, other materials which can be applied in the form of a thin, coherent layer are also suitable. By way of example, silicon is particularly suitable and, unlike aluminum, gives a transparent barrier layer. The ceramic layer is preferably comprised of oxides of elements of the 2^{nd}, 3^{rd} or 4^{th} main group of the periodic table of the elements, in particular oxides of magnesium or aluminum, or of silicon, or their mixtures. It is generally preferable to use those metallic or ceramic materials which can be applied at reduced pressure or in vacuo (=vacuum thin-film process).

The ceramic layer comprised of Al₂O₃ or of SiOₓ is applied to the film in this process in such a way that the number x is between 0.9 and 2. Aluminum is preferably vaporized in this process with introduction of oxygen, or silicon monoxide (SiO), if appropriate with introduction of oxygen. The layer comprised of SiOₓ may, if appropriate, also be produced via plasma polymerization (e.g. by way of hexamethyldisiloxane, CH₄).

In another preferred variant, x of the ceramic layer comprised of SiOₓ is a number that is preferably from 1.3 to 2, in particular from 1.5 to 1.8. The features of a film coated in this way are again a good barrier (even after sterilization), but also in particular a very low level of discoloration (yellowing).

By way of example, the ceramic layers using SiOₓ may be deposited on the film by processes involving vacuum thin-film technology, preferably via electron-beam vaporization, and in each case here the ceramic layer has a protective covering of another film or of a laminating adhesive or, by way of example, of an ORMOCER and laminating adhesive.

Simultaneous vaporization of silicon dioxide (SiO₂) and of metallic silicon from a single vaporization source, i.e. from a mixture comprised of SiO₂ and Si, is used in vacuo to deposit a ceramic layer comprised of SiOₓ by means of a vacuum thin-film process known per se, where x is a number from, preferably, 0.9 to 2.

Amounts of up to 50 mol %, preferably from 5 to 30 mol %, based in each case on the SiO₂, of other additives, such as Al₂O₃, B₂O₃, and MgO may be added to the SiO₂ as materials to be vaporized to produce a ceramic layer comprised of SiOₓ, where x is a number from 1.3 to 2.

Examples of other additives which may be added to the materials to be vaporized are amounts of up to 50 mol %, preferably from 5 to 30 mol % in each case based on Si, are Al, B, and/or Mg in pure form, or in the form of Si alloy.

The quantitative ratio of SiO₂, Al₂O₃, B₂O₃, and MgO to Si, Al, B and Mg is set, by way of example, in such a way as to give a stoichiometric oxygen deficit that is preferably from 10 to 30%, based on the entirety of the pure oxides in the vaporized material.

When a ceramic layer comprised of SiOₓ is produced, where x is a number from 0.9 to 1.2, it is possible to vaporize silicon monoxide (SiO) instead of simultaneous vaporization of SiO₂ and Si.

Plasma pretreatment of the PET film prior to the SiOₓ coating process leads to a further improvement in barrier properties.

The film composite preferably finally used for packaging purposes comprises not only the SiOₓ-coated polyester film but also, depending on the intended application, other films, such as films comprised of PET or comprised of oriented PA (OPA); or the film composite may have been coated with a sealable layer comprised, by way of example, of PP or PE, in order to control sealing properties. The preferred method of joining the individual films to give a film composite uses laminating adhesives based on polyurethane.

The gloss of the untreated film surfaces (i.e. of the surfaces which have not been metallized or, respectively, ceramic-coated) is preferably greater than 80 at an angle of incidence of 20°. In one preferred embodiment, the gloss of the film surfaces is more than 100, and in one particularly preferred embodiment it is more than 120.

The haze of the uncoated (untreated) film is preferably smaller than 20%. In one preferred embodiment, the haze of the uncoated film is less than 15%, and in one particularly preferred embodiment it is less than 10%. The very low haze makes the film particularly suitable for the packaging application (in particular if the film has been coated with a transparent barrier layer).

Another advantage of the invention is that the production costs of the inventive film are not substantially above those of a film comprised of standard polyesters. It has also been ensured that an amount that is preferably from 5 to 60% by weight, in particular from 10 to 50% by weight, in each case based on the total weight of the film, of cut material arising directly in the plant during film production can be used again in the form of regrind for film production, without any significant resultant adverse effect on the physical properties of the film.

The inventive film is particularly suitable for packaging of foods or of other consumable items. It also has excellent suitability for metallizing or vacuum-coating with ceramic substances. It features excellent barrier properties with respect to gases such as oxygen and CO₂.

The table below (Table 1) gives the most important inventive and preferred properties of the film.

TABLE 1

| | | | very | | |
|---|---|---|---|---|---|
| | | | particularly | | |
| | | particularly | preferred | | |
| Film or base layer | preferred range | preferred range | range | Unit | Test method |
| Component I (= thermoplastic polyester) | 55-95 | 60-95 | 65-95 | % by weight | |
| Component II (= poly(m-xyleneadipamide) (MXD6) | 5-45 | 5-40 | 5-35 | % by weight | |
| Melt viscosity of MXD6 used | <6000 | <5000 | <4000 | poise | in capillary |
| | | | | | rheometer, |
| | | | | | 280° C. |
| Biaxial orientation | sequential | +first MD, then | +MD, two- | | |
| | | TD | stage | | |
| Longitudinal stretching, stretching ratio λ_{MD} | 3.1:1-5.0:1 | 3.2:1-4.9:1 | 3.3:1-4.8:1 | | |
| Transverse stretching, stretching ratio λ_{TD} | 3.2:1-5.0:1 | 3.3:1-4.8:1 | 3.4:1-4.6:1 | | |
| Filler concentration | 0.02-1 | 0.04-0.8 | 0.06-0.6 | % by weight | |
| Film properties | | | | | |
| OTR of 12 μm thickness metallized film | <0.5 | <0.45 | <0.4 | cm³/(m² · bar · d) | DIN 53 380, |
| | | | | | Part 3 |
| OTR of 12 μm thickness ceramic-coated film | <1.0 | <0.95 | <0.9 | cm³/(m² · bar · d) | DIN 53 380, |
| | | | | | Part 3 |
| Film thickness | 6-300 | 8-200 | 10-100 | μm | |
| Gloss of uncoated film | >80 | >100 | >120 | — | DIN 67 530 |
| (test angle = 20°) | | | | | |
| Haze of uncoated film | <20 | <15 | <10 | % | ASTM |
| | | | | | D1003-52 |
| Modulus of elasticity of film, | | | | | |
| in MD | >3500 | >4000 | >4500 | N/mm² | DIN 53 457 |
| in TD | >3500 | >4000 | >4500 | | |
| Ultimate tensile strength of film, | | | | | |
| in MD | >160 | >170 | >180 | N/mm² | DIN 53 455 |
| in TD | >200 | >210 | >220 | | |

Test methods

The following methods were used to characterize the raw materials and the films:

(DIN=Deutsches Institut für Normung [German Institute for Standardization]

ASTM=American Society for Testing and Materials)

(1) Oxygen Transmission (OTR=Oxygen Transmission Rate)

The level of the oxygen barrier was measured using an OXTRAN® 100 from Mocon Modern Controls (USA) to DIN 53 380, Part 3 (23° C., 50% relative humidity, on both sides of the film). OTR was always measured here on film thickness 12 μm.

(2) Haze

Haze of the untreated film was determined to ASTM D1003-52.

(3) SV (Standard Viscosity)

Standard viscosity SV (DCA) is measured in dichloroacetic acid by a method based on DIN 53726. Intrinsic viscosity (IV) is calculated from standard viscosity as follows:
IV (DCA)=6.907·10⁻⁴ SV (DCA)+0.063096

(4) Gloss

Gloss of the uncoated film was determined to DIN 67530. Reflectance was measured, this being an optical value characteristic of a film surface. Using a method based on the standards ASTM D523-78 and ISO 2813, the angle of incidence was set at 20° or 60°. A beam of light hits the flat test surface at the set angle of incidence and is reflected or scattered by the surface. A proportional electrical variable is displayed, representing light rays hitting the photoelectronic detector. The value measured is dimensionless and has to be stated together with the angle of incidence. The gloss test values given in the examples were measured at an angle of incidence of 20°.

(5) Roughness

The roughness Rₐ of the uncoated film was determined to DIN 4768 with a cut-off of 0.25 mm. This test was not carried out on a glass plate, but in a ring. In the ring method, the film is clamped into a ring so that neither of the two surfaces is in contact with a third surface (e.g. glass).

(6) Modulus of Elasticity

Modulus of elasticity is determined to DIN 53 457 or ASTM 882.

(7) Ultimate Tensile Strength, Tensile Strain at Break

Ultimate tensile strength and tensile strain at break are determined to DIN 53 455.

(8) Coefficient of Friction

The coefficient of fricition was determined using DIN 53375 or ASTM-D 1894.

### EXAMPLES

The following examples illustrate the invention. The products used (trade marks and producer) are in each case stated only once, and then also apply to the subsequent examples.

### Example 1

Chips comprised of polyethylene terephthalate (prepared by way of the transesterification process using Mn as transesterification catalyst, Mn concentration in polymer: 100 ppm; dried at a temperature of 150° C. to a residual moisture level below 100 ppm) and poly(m-xyleneadipamide) (MXD6), likewise dried at a temperature of 150° C., were introduced in a mixing ratio of 90:10 into the extruder (twin-screw extruder with two vents), and a single-layer film was extruded. The film was oriented longitudinally (in two stages) and transversely, the product being a transparent film with total thickness 12 μm. The film was then metallized in vacuo with aluminum on one side in an industrial metallizer (Topmet, Lybold-Heraeus, Germany). The coating speed was 5 m/s.

| Film structure | |
|---|---|
| 10% by weight | poly(m-xyleneadipamide) (MXD6) from Mitsubishi Gas |
| | Chemical Co., product name NYLON ® MXD6 6007, |
| | with melt viscosity of 5000 poise |
| 80% by weight | polyethylene terephthalate 4023 from KoSa, Germany, |
| | with SV 800 |
| 10% by weight | polyester from KoSa with SV 800, comprised of 99% |
| | by weight of polyethylene terephthalate 4023 from |
| | KoSa and 1.0% by weight of silica particles |
| | (SYLYSIA ® 320 from Fuji, Japan) with d₅₀ 2.5 μm. |

The production conditions in the individual steps of the process are as follows:

| | | | |
|---|---|---|---|
| Extrusion | Max. temperature | | 280° C. |
| | Take-off roller temperature | | 25° C. |
| Longitudinal | Longitudinal stretching ratio | λ_{MDO} | 4.0 |
| stretching | | λ₁ | 1.75 |
| | Stretching temperature | | 115° C. |
| | during 1^{st} stretching process | λ₂ | 2.3 |
| | Stretching temperature | | 113° C. |
| | during 2^{nd} stretching process | | |
| | Heating temperature | 1^{st} roller | 70° C. |
| | | final roller | 115° C. |
| Transverse | Stretching temperature | start | 110° C. |
| stretching | | end | 134° C. |
| | Transverse stretching ratio | | 3.8 |
| Setting | Temperature | | 230° C. |
| | Duration | | 3 s |

The surfaces of the film had the high gloss demanded, and the film had the low haze demanded, the low OTR demanded, and the high mechanical strength demanded. The film was moreover capable of very efficient production, i.e. without break-offs, and also exhibited the desired processing behavior (inter alia good winding quality, e.g. no blocking points, no longitudinal corrugations, no raised edges).

### Example 2

Chips comprised of a copolyester comprised of terephthalate units and of isophthalic units, and of ethylene glycol units (the proportion of ethylene terephthalate being 90 mol % and the proportion of ethylene isophthalate being 10 mol %, prepared by way of the transesterification process using Mn as transesterification catalyst, Mn concentration in polymer: 100 ppm; dried at a temperature of 100° C. to a residual moisture level below 100 ppm) and poly(m-xyleneadipamide) (MXD6), likewise dried at a temperature of 100° C., were introduced in a mixing ratio of 90:10 into the extruder (twin-screw extruder), and a single-layer film was extruded. The film was oriented longitudinally (in two stages) and transversely, the product being a transparent film with total thickness 12 μm. The film was then metallized in vacuo with aluminum on one side in an industrial metallizer. The coating speed was 5 m/s.

| Film structure | |
|---|---|
| 10% by weight | poly(m-xyleneadipamide) (MXD6) from Mitsubishi Gas |
| | Chemical Co., product name NYLON ® MXD6 6007, |
| | with melt viscosity of 5000 poise |
| 80% by weight | polyester copolymer (ethylene terephthalate 90 mol %, |
| | ethylene isophthalate 10 mol %, KoSa, Germany) with |
| | SV 800 |
| 10% by weight | polyester from KoSa with SV 800, comprised of 99% |
| | by weight of polyester copolymer (ethylene |
| | terephthalate 90 mol %, ethylene isophthalate 10 mol % |
| | from KoSa), and 1.0% by weight of silica particles |
| | (SYLYSIA ® 320 from Fuji, Japan) with d₅₀ 2.5 μm. |

The production conditions in the individual steps of the process are as follows:

| | | | |
|---|---|---|---|
| Extrusion | Max. temperature | | 270° C. |
| | Take-off roller temperature | | 25° C. |
| Longitudinal | Longitudinal stretching ratio | λ_{MDO} | 4.2 |
| stretching | | λ₁ | 1.83 |
| | Stretching temperature | | 112° C. |
| | during 1^{st} stretching process | λ₂ | 2.3 |
| | Stretching temperature | | 106° C. |
| | during 2^{nd} stretching process | | |
| | Heating temperature | 1^{st} roller | 70° C. |
| | | final roller | 112° C. |
| Transverse | Stretching temperature | start | 105° C. |
| stretching | | end | 127° C. |
| | Transverse stretching ratio | | 3.8 |
| Setting | Temperature | | 225° C. |
| | Duration | | 3 s |

The surface of the film had the high gloss demanded, and the film had the low haze demanded, the low OTR demanded, and the high mechanical strength demanded. The film was moreover capable of very efficient production, i.e. without break-offs, and also exhibited the desired processing behavior. (inter alia good winding quality, e.g. no blocking points, no longitudinal corrugations, no raised edges).

### Example 3

The mixing ratio of MXD6 and polyethylene terephthalate was changed from that of Example 1. In this example, chips comprised of polyethylene terephthalate and poly(m-xyleneadipamide) (MXD6, dried) were introduced in a mixing ratio of 85:15 into the extruder (twin-screw extruder), and a single-layer film was extruded. The film was oriented longitudinally (in two stages) and transversely, the product being a transparent film with total thickness 12 μm. The film was then metallized in vacuo with aluminum on one side in an industrial metallizer. The coating speed was 5 m/s.

| Film structure | |
|---|---|
| 15% by weight | poly(m-xyleneadipamide) (MXD6) from Mitsubishi Gas |
| | Chemical Co., product name NYLON ® MXD6 6007, |
| | with melt viscosity of 5000 poise |
| 75% by weight | polyethylene terephthalate 4023 from KoSa, Germany, |
| | with SV 800 |
| 10% by weight | polyester from KoSa with SV 800, comprised of 99% |
| | by weight of polyethylene terephthalate 4023 from |
| | KoSa and 1.0% by weight of silica particles |
| | (SYLYSIA ® 320 from Fuji, Japan) with d₅₀ 2.5 μm. |

The production conditions in the individual steps of the process are as follows:

| | | | |
|---|---|---|---|
| Extrusion | Max. temperature | | 280° C. |
| | Take-off roller temperature | | 25° C. |
| Longitudinal | Longitudinal stretching ratio | λ_{MDO} | 3.8 |
| stretching | | λ₁ | 1.65 |
| | Stretching temperature | | 115° C. |
| | during 1^{st} stretching process | λ₂ | 2.3 |
| | Stretching temperature | | 113° C. |
| | during 2^{nd} stretching process | | |
| | Heating temperature | 1^{st} roller | 70° C. |
| | | final roller | 115° C. |
| Transverse | Stretching temperature | start | 110° C. |
| stretching | | end | 137° C. |
| | Transverse stretching ratio | | 3.8 |
| Setting | Temperature | | 230° C. |
| | Duration | | 3 s |

The surface of the film had the high gloss demanded, and the film had the low haze demanded, the low OTR demanded, and the high mechanical strength demanded. The film was moreover capable of very efficient production, i.e. without break-offs, and also exhibited the desired processing behavior, as in the preceding examples.

### Example 4

The mixing ratio of MXD6 and polyethylene terephthalate was changed from that of Example 1. In this example, chips comprised of polyethylene terephthalate and poly(m-xyleneadipamide) (MXD6, dried) were introduced in a mixing ratio of 75:25 into the extruder (twin-screw extruder), and a single-layer film was extruded. The film was oriented longitudinally (in two stages) and transversely, the product being a transparent film with total thickness 12 μm. The film was then metallized in vacuo with aluminum on one side in an industrial metallizer. The coating speed was 5 m/s.

| Film structure | |
|---|---|
| 25% by weight | poly(m-xyleneadipamide) (MXD6) from Mitsubishi Gas |
| | Chemical Co., product name NYLON ® MXD6 6007, |
| | with melt viscosity of 5000 poise |
| 65% by weight | polyethylene terephthalate 4023 from KoSa, Germany, |
| | with SV 800 |
| 10% by weight | polyester from KoSa with SV 800, comprised of 99% |
| | by weight of polyethylene terephthalate 4023 from |
| | KoSa and 1.0% by weight of silica particles |
| | (SYLYSIA ® 320 from Fuji, Japan) with d₅₀ 2.5 μm. |

The production conditions in the individual steps of the process are as follows:

| | | | |
|---|---|---|---|
| Extrusion | Max. temperature | | 280° C. |
| | Take-off roller temperature | | 25° C. |
| Longitudinal | Longitudinal stretching ratio | λ_{MDO} | 3.7 |
| stretching | | λ₁ | 1.61 |
| | Stretching temperature | | 118° C. |
| | during 1^{st} stretching process | λ₂ | 2.3 |
| | Stretching temperature | | 115° C. |
| | during 2^{nd} stretching process | | |
| | Heating temperature | 1^{st} roller | 70° C. |
| | | final roller | 118° C. |
| Transverse | Stretching temperature | start | 110° C. |
| stretching | | end | 139° C. |
| | Transverse stretching ratio | | 3.8 |
| Setting | Temperature | | 230° C. |
| | Duration | | 3 s |

The surface of the film had the high gloss demanded, and the film had the low haze demanded, the low OTR demanded, and the high mechanical strength demanded. The film was moreover capable of very efficient production, i.e. without break-offs, and also exhibited the desired processing behavior, as in the preceding examples.

### Example 5

The mixing ratio of MXD6 and polyethylene terephthalate was changed from that of Example 1. In this example, chips comprised of polyethylene terephthalate and poly(m-xyleneadipamide) (MXD6) were introduced in a mixing ratio of 60:40 into the extruder (twin-screw extruder), and a single-layer film was extruded. The film was oriented longitudinally (in two stages) and transversely, the product being a transparent film with total thickness 12 μm. The film was then metallized in vacuo with aluminum on one side in an industrial metallizer. The coating speed was 5 m/s.

| Film structure | |
|---|---|
| 40% by weight | poly(m-xyleneadipamide) (MXD6) from Mitsubishi Gas |
| | Chemical Co., product name NYLON ® MXD6 6007, |
| | with melt viscosity of 5000 poise |
| 50% by weight | polyethylene terephthalate 4023 from KoSa, Germany, |
| | with SV 800 |
| 10% by weight | polyester from KoSa with SV 800, comprised of 99% |
| | by weight of polyethylene terephthalate 4023 from |
| | KoSa and 1.0% by weight of silica particles |
| | (SYLYSIA ® 320 from Fuji, Japan) with d₅₀ 2.5 μm. |

The production conditions in the individual steps of the process are as follows:

| | | | |
|---|---|---|---|
| Extrusion | Max. temperature | | 280° C. |
| | Take-off roller temperature | | 25° C. |
| Longitudinal | Longitudinal stretching ratio | λ_{MDO} | 3.6 |
| stretching | | λ₁ | 1.6 |
| | Stretching temperature | | 120° C. |
| | during 1^{st} stretching process | λ₂ | 2.25 |
| | Stretching temperature | | 118° C. |
| | during 2^{nd} stretching process | | |
| | Heating temperature | 1^{st} roller | 70° C. |
| | | final roller | 120° C. |
| Transverse | Stretching temperature | start | 110° C. |
| stretching | | end | 140° C. |
| | Transverse stretching ratio | | 3.7 |
| Setting | Temperature | | 230° C. |
| | Duration | | 3 s |

The surface of the film had the high gloss demanded, and the film had the low haze demanded, the low OTR demanded, and the high mechanical strength demanded. The film was moreover capable of very efficient production, i.e. without break-offs, and also exhibited the desired processing behavior, as in the preceding examples.

### Example 6

Coextrusion is now used to produce a three-layer film with ABC structure, unlike in Example 1. The constitution of the base layer (B) here was unchanged from Example 1. To this end, chips comprised of polyethylene terephthalate and of a filler were also introduced into the extruder (twin-screw extruder) for the outer layers (A and C). This gave a transparent, three-layer film with ABC structure and with a total thickness of 12 μm. The thickness of each of the outer layers (A) and (C) was 1.0 μm. The outer layer (A) of the film was then metallized in vacuo with aluminum in an industrial metallizer. The coating speed was 5 m/s.

| | |
|---|---|
| Outer layer (A): | |
| 20% by weight | poly(m-xyleneadipamide) (MXD6) from Mitsubishi |
| | Gas Chemical Co., product name NYLON ® MXD6 |
| | 6007, with melt viscosity of 5000 poise |
| 80% by weight | polyethylene terephthalate 4023 from KoSa, Germany, |
| | with SV 800 |
| Outer layer (C): | |
| 80% by weight | polyethylene terephthalate 4023 from KoSa, Germany, |
| | with SV 800 |
| 20% by weight | polyester from KoSa with SV 800, comprised of 99% |
| | by weight of polyethylene terephthalate 4023 from |
| | KoSa and 1.0% by weight of silica particles |
| | (SYLYSIA ® 320 from Fuji, Japan) with d₅₀ 2.5 μm. |

The production conditions in the individual steps of the process were similar to those in Example 1. The film had the low haze demanded and the low OTR demanded. The film was also capable of very efficient production, i.e. without break-offs, and also exhibited the desired processing behavior.

### Comparative Example

A film was produced corresponding to Example 1 of JP 2001-001399. The roughness values for this film are too high, and the gloss of the film, and in particular the mechanical properties, are not within the range. The wound-up roll also exhibits blocking points (points where there was blocking of the laps of film) due to absence of fillers within the film.

The properties and the structure of the films produced in the examples and in the comparative examples (CE) are given in Table 2.

TABLE 2

| | | | | Proportion | | | | | Ultimate | | Tensile | | OTR of | Rough- | Co- |
|---|---|---|---|---|---|---|---|---|---|---|---|---|---|---|---|
| | | Film | | of | | Gloss of | Modulus of | | Tensile | | strain | | barrier-coated | ness | efficient |
| | | thick- | | MXD6 in | | both | elasitcity in | | strength | | at break | | film | of both | of friction |
| | | ness | Film | film/base | Haze | surfaces | MDO | TDO | MDO | TDO | MDO | TDO | cm³/m² · | surfaces | of both |
| | | μm | structure | layer % | (uncoated) % | (uncoated) | N/mm² | | N/mm² | | % | | bar · d | μm | surfaces % |
| Ex- | 1 | 12 | B | 10 | 5 | 130 | 4800 | 5200 | 170 | 220 | 100 | 80 | 0.3 | 70 | 0.4 |
| am- | 2 | 12 | B (IPA) | 10 | 4 | 140 | 4600 | 5000 | 160 | 200 | 120 | 90 | 0.37 | 60 | 0.45 |
| ples | 3 | 12 | B | 15 | 6 | 130 | 4900 | 5400 | 180 | 230 | 120 | 95 | 0.28 | 75 | 0.4 |
| | 4 | 12 | B | 25 | 7 | 130 | 4900 | 5500 | 190 | 230 | 120 | 95 | 0.2 | 75 | 0.4 |
| | 5 | 12 | B | 40 | 9 | 130 | 5100 | 6000 | 200 | 230 | 120 | 95 | 0.15 | 80 | 0.4 |
| | 6 | 12 | ABC | 10 | 3.8 | 150 | 4600 | 5000 | 160 | 200 | 120 | 90 | 0.23 | 60 | 0.45 |
| CE | 1 | 12 | B | 20 | 8 | 75 | 3300 | 3400 | 150 | 160 | 130 | 100 | 22 | 100 | >1 |

1. A biaxially oriented polyester film comprising
a) thermoplastic polyester and poly(m-xyleneadipamide) (MXD6), said film exhibiting
b) a modulus of elasticity of at least 3500 N/mm² in both orientation directions, and further comprising
a ceramic-coated or metallized layer on at least one surface.

2. The polyester film as claimed in claim 1, which further comprises fillers.

3. The polyester film as claimed in claim 1, which comprises from 5 to 45% by weight of poly(m-xyleneadipamide).

4. The polyester film as claimed claim 1, wherein the melt viscosity of the poly(m-xyleneadipamide) is smaller than 6000 poise.

5. The polyester film as claimed in claim 2, which comprises from 0.02 to 1% by weight of said fillers.

6. The polyester film as claimed in claim 1, which comprises at least 55% by weight of thermoplastic polyester.

7. The polyester film as claimed in claim 1, wherein the thermoplastic polyester contains terephthalic acid units and/or isophthalic acid units and/or naphthalene-2,6-dicarboxylic acid units.

8. The polyester film as claimed in claim 1, wherein the thermoplastic polyester contains isophthalic acid units, terephthalic acid units, and ethylene glycol units.

9. The polyester film as claimed in claim 1, wherein the thermoplastic polyester used comprises polyethylene terephthalate.

10. The polyester film as claimed in claim 1, said film comprising a base layer (B) and one or two outer layers (A) and (C), where the outer layers (A) and (C) may be identical or different.

11. The polyester film as claimed in claim 10, wherein the outer layers (A) and/or (C) comprise the thermoplastic polyester used for the base layer (B).

12. The polyester film as claimed in claim 10, wherein the polymer used for the outer layers (A) and/or (C) comprises polyethylene terephthalate or a polyester copolymer which contains isophthalic acid units, terephthalic acid units, and ethylene glycol units.

13. The polyester film as claimed in claim 1, which has been metallized with aluminum.

14. The polyester film as claimed in claim 13, wherein metallized film having a total thickness of 12 μm exhibits an oxygen transmission (OTR) smaller than 0.5 cm³ m⁻² d⁻¹ bar⁻¹.

15. The polyester film as claimed in claim 1 wherein the film is ceramic-coated and ceramic-coated film having total thickness of 12 μm exhibits an oxygen transmission (OTR) is smaller than 1 cm³ m⁻² d⁻¹ bar⁻¹.

16. The polyester film as claimed in claim 1, wherein the gloss of the uncoated film is greater than 80.

17. The polyester film as claimed in claim 1, wherein the haze of the uncoated film is smaller than 20%.

18. The polyester film as claimed in claim 1, wherein said film is produced with a sequential stretching process.

19. A process for production of a polyester film as claimed claim 1, said process comprising the steps of
a) extruding or stretching the film,
b) sequentially stretching the extruded film,
c) heat-setting the stretched film, and
d) applying a metal layer or ceramic layer to the heat-set film.

20. The process as claimed in claim 19, wherein the sequential stretching comprises first orienting the film in the machine direction and then orienting the film in the transverse direction.

21. The process as claimed in claim 20, wherein the orienting in the machine direction takes place in 2 stages.

22. Packaging material comprising a polyester film as claimed in claim 1.

23. Packaging material as claimed in claim 22, wherein said packaging is food packaging or consumable item packaging.
